(19) United States
(12) Patent Application Publication
(10) Pub. No.: US 2026/0163098 A1
(43) Pub. Date: Jun. 11, 2026

(54) BATTERY TEMPERATURE CONTROL DEVICE

(71) Applicant: TOYOTA JIDOSHA KABUSHIKI KAISHA, Toyota-shi (JP)

(72) Inventors: Takahiro Watanabe, Toyota-shi (JP); Masashi Kobayashi, Toyota-shi (JP); Hirotaka Sasaki, Nagoya-shi (JP); Yusuke Nishimura, Kasugai-shi (JP)

(73) Assignee: TOYOTA JIDOSHA KABUSHIKI KAISHA, Toyota-shi (JP)

(21) Appl. No.: 19/402,768

(22) Filed: Nov. 26, 2025

(30) Foreign Application Priority Data
Dec. 5, 2024 (JP) 2024-212287

(51) Int. Cl. H01M 10/613; H01M 10/625; H01M 10/635; H01M 10/6568; H01M 10/663

(52) U.S. Cl. CPC H01M 10/613; H01M 10/625; H01M 10/635; H01M 10/6568; H01M 10/663

(57) ABSTRACT

When the temperature TB of a battery is higher than or equal to a threshold S and there is a request to cool the battery, the battery is cooled in a second cooling mode in a region where the outside air temperature To is lower than or equal to a threshold S2. In the second cooling mode, the battery is cooled by heat dissipation from a low-temperature radiator. When the temperature TB is higher than or equal to a threshold S3, the battery is cooled in a first cooling mode in which the battery is cooled using a refrigeration cycle (refrigerant circuit). In a region where the temperature TB is lower than the threshold S3 and the outside air temperature To is higher than the threshold S2, the cooling mode switching control is performed.

### CROSS-REFERENCE TO RELATED APPLICATION

This application claims priority to Japanese Patent Application No. 2024-212287 filed on Dec. 5, 2024. The disclosure of the above-identified application, including the specification, drawings, and claims, is incorporated by reference herein in its entirety.

### BACKGROUND

### 1. Technical Field

The present disclosure relates to battery temperature control devices.

### 2. Description of Related Art

Japanese Unexamined Patent Application Publication No. 2020-185829 (JP 2020-185829 A) discloses an in-vehicle temperature control device that controls, for example, the temperature of a battery that supplies power to a motor. This in-vehicle temperature control device cools the battery using a refrigeration cycle (refrigeration circuit) and also cools the battery using heat dissipation from a radiator.

### SUMMARY

When there is a request to cool a battery and the temperature of the battery is high, cooling using a refrigeration cycle preferable in order to appropriately cool the battery. However, when a compressor of the refrigeration cycle is driven by power from the battery, the power from the battery is consumed for cooling, which reduces the vehicle's driving range. When there is a request to cool the battery but the temperature of the battery is relatively low, it is possible to maintain the battery at an appropriate temperature by cooling the battery using heat dissipation from a radiator. However, when the battery is cooled using heat dissipation from the radiator, the cooling capacity may decrease (sufficient cooling may not be ensured) in high ambient temperature environments, making it difficult to maintain the battery at an appropriate temperature. Accordingly, it is desirable to appropriately select between battery cooling using the refrigeration cycle and battery cooling using heat dissipation from the radiator.

An object of the present disclosure is to appropriately select between battery cooling using a refrigeration cycle and battery cooling using heat dissipation from a radiator.

A battery temperature control device of the present disclosure includes: a battery thermal circuit configured to circulate a heat transfer medium to control the temperature of a battery; and a control device configured to select between a first cooling mode and a second cooling mode. The first cooling mode is a mode in which the battery is cooled by cooling the heat transfer medium using a refrigeration cycle. The second cooling mode is a mode in which the battery is cooled by dissipating heat of the heat transfer medium to the outside air via a radiator. The control device is configured to, when there is a request to cool the battery, and the temperature of the battery is lower than or equal to a first set temperature and the outside air temperature is higher than or equal to a second set temperature, select the second cooling mode when the temperature of the heat transfer medium is lower than or equal to a target temperature, and select the first cooling mode when a condition in which the temperature of the heat transfer medium is higher than the target temperature continues for a predetermined time or longer.

In this configuration, the temperature of the battery is controlled by the heat transfer medium circulating through the battery thermal circuit. The control device cools the battery by selecting between the first cooling mode in which the battery is cooled by cooling the heat transfer medium using the refrigeration cycle, and the second cooling mode in which the battery is cooled by dissipating heat of the heat transfer medium to the outside air via the radiator. When the temperature of the battery is lower than or equal to the first set temperature, the temperature of the battery is relatively low. Therefore, the battery can be maintained at an appropriate temperature by the second cooling mode. When the outside air temperature is higher than or equal to the second set temperature, the cooling capacity of the second cooling mode may be reduced, and the battery may not be maintained at an appropriate temperature.

When there is a request to cool the battery, and the temperature of the battery is lower than or equal to the first set temperature and the outside air temperature is higher than or equal to the second set temperature, the control device selects the second cooling mode when the temperature of the heat transfer medium is lower than or equal to the target temperature. Since the temperature of the heat transfer medium is lower than or equal to the target temperature and the amount of heat transferred from the battery to the heat transfer medium is relatively large, the battery can be maintained at an appropriate temperature by the second cooling mode.

When there is a request to cool the battery, and the temperature of the battery is lower than or equal to the first set temperature and the outside air temperature is higher than or equal to the second set temperature, the control device selects the first cooling mode when the condition in which the temperature of the heat transfer medium is higher than the target temperature continues for the predetermined time or longer. When the condition in which the temperature of the heat transfer medium is higher than the target temperature continues for the predetermined time or longer, it can be determined that the cooling capacity of the second cooling mode is insufficient. Therefore, cooling is performed in the first cooling mode. The battery can thus be maintained at an appropriate temperature. Accordingly, it is possible to appropriately select between battery cooling using the refrigeration cycle and battery cooling using heat dissipation from the radiator.

The control device may be configured to set the target temperature based on an input or output current of the battery.

The amount of heat generated by the battery increases as the input or output current of the battery increases. With this configuration, the target temperature of the heat transfer medium can be set in consideration of the amount of heat generated by the battery. It is therefore possible to appropriately select between battery cooling using the refrigeration cycle and battery cooling using heat dissipation from the radiator.

The control device may be configured to select the second cooling mode when the outside air temperature is lower than the second set temperature.

In this configuration, when the outside air temperature is lower than the second set temperature and the cooling capacity of the second cooling mode is high, the battery is cooled in the second cooling mode. This can reduce energy consumption of the refrigeration cycle.

The control device may be configured to select the first cooling mode when the temperature of the battery is higher than the first set temperature.

In this configuration, when the temperature of the battery is higher than the first set temperature and cooling using the refrigeration cycle is preferable to appropriately cool the battery, the battery is cooled in the first cooling mode. Therefore, the battery can be maintained at an appropriate temperature.

The control device may be configured to select the first cooling mode when the outside air temperature is higher than or equal to a third set temperature that is higher than the second set temperature.

In this configuration, when the outside air temperature is higher than the third set temperature and cooling of the battery cannot be expected through heat dissipation from the radiator, the battery is cooled in the first cooling mode. Therefore, the battery can be maintained at an appropriate temperature.

According to the present disclosure, it is possible to appropriately select between battery cooling using the refrigeration cycle and battery cooling using heat dissipation from the radiator.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic configuration of a battery temperature control device according to an embodiment;

FIG. 2 illustrates a first cooling mode according to the embodiment;

FIG. 3 illustrates a second cooling mode according to the embodiment;

FIG. 4 is a flowchart illustrating processing of battery cooling control that is performed by an electronic control unit (ECU);

FIG. 5 is a flowchart illustrating processing of cooling mode switching control; and

FIG. 6 is a graph illustrating regions of cooling modes according to the embodiment.

### DETAILED DESCRIPTION OF EMBODIMENTS

An embodiment of the present disclosure will be described in detail with reference to the drawings. The same or corresponding portions are denoted by the same signs throughout the drawings, and description thereof will not be repeated.

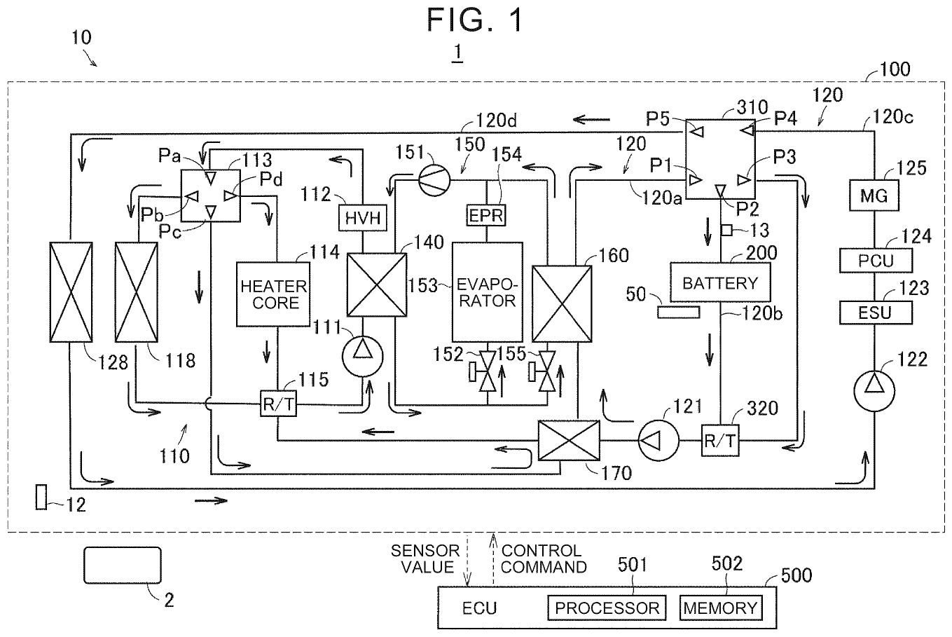

FIG. 1 shows a schematic configuration of a battery temperature control device 10 according to the present embodiment. In the present embodiment, the battery temperature control device 10 controls the temperature of a battery 200 mounted on a vehicle 1. The vehicle 1 is an electrified vehicle and, for example, may be a battery electric vehicle. However, the vehicle 1 may alternatively be another type of electrified vehicle such as a plug-in hybrid electric vehicle, or may be an industrial vehicle.

The battery temperature control device 10 includes a thermal management circuit 100 and an electronic control unit (ECU) 500. The ECU 500 includes a processor 501 and a memory 502. The processor 501 executes programs stored in the memory 502 to perform various types of thermal management control including temperature control of the battery 200. The ECU 500 is an example of the “control device” in the present disclosure.

The battery temperature control device 10 is configured to perform thermal management of the vehicle 1 using a heat transfer medium in the thermal management circuit 100. The battery temperature control device 10 also serves as a thermal management device for the vehicle. The thermal management circuit 100 includes a first circuit 110, a second circuit 120, a condenser 140, a refrigerant circuit 150, a chiller 160, and a water-to-water heat exchanger 170. The second circuit 120 is an example of the “battery thermal circuit” of the present disclosure, and controls the temperature of the battery 200.

The first circuit 110 includes a first channel through which a high-temperature-side heat transfer medium flows. The first circuit 110 includes a pump 111, an electric heater 112 for heating, a four-way valve 113, a heater core 114, a reservoir tank (R/T) 115, and a high-temperature radiator 118. The four-way valve 113 is controlled by the ECU 500 to switch the flow path of the high-temperature-side heat transfer medium. The pump 111 circulates the high-temperature-side heat transfer medium through the first circuit 110. The high-temperature-side heat transfer medium exchanges heat with each device as it passes therethrough. The heater core 114 is used as a heating source (heat source) for an air conditioning unit 2. The high-temperature-side heat transfer medium may be, for example, long-life coolant (LLC).

The five-way valve 310 switches the flow path of a low-temperature-side heat transfer medium flowing through the second circuit 120. The low-temperature-side heat transfer medium may be an insulating oil or an electrically insulating (low-conductivity) antifreeze. The low-temperature-side heat transfer medium is the “heat transfer medium” of the present disclosure. The low-temperature-side heat transfer medium exchanges heat with various devices. Accordingly, each device includes a heat exchanger (or serves as a heat exchanger). The five-way valve 310 includes five ports P1 to P5. The ECU 500 controls the five-way valve 310.

Channels 120a, 120b are connected to the ports P1, P2 of the five-way valve 310, respectively. The channel 120a connects the port P1 and a reservoir tank 320. The channel 120b connects the port P2 and the reservoir tank 320.

A pump 121, the water-to-water heat exchanger 170, and the chiller 160 are disposed in the channel 120a. The battery 200 is disposed in the channel 120b. When the ports P1, P2 are connected and the pump 121 is operated, the low-temperature-side heat transfer medium circulates through the channels 120a, 120b. In the chiller 160, the low-temperature-side heat transfer medium dissipates heat (the low-temperature-side heat transfer medium is cooled), whereby the battery 200 can be cooled. In the water-to-water heat exchanger 170, the low-temperature-side heat transfer medium absorbs heat (the low-temperature-side heat transfer medium is heated by the high-temperature-side heat transfer medium), whereby the battery 200 can be heated.

The battery 200 is a traction battery for the vehicle 1, and may be, for example, a lithium-ion battery. The battery 200 is configured to be charged via an external power source (not shown). The battery 200 is provided with a monitoring unit 50. The monitoring unit 50 detects a battery temperature TB, a battery voltage VB, and a battery input or output current IB, and outputs them to the ECU 500. The monitoring unit 50 also calculates the state of charge (SOC) of the battery 200 and outputs it to the ECU 500.

Channels 120c, 120d are connected to the ports P4, P5 of the five-way valve 310, respectively. The channels 120c, 120d connect the ports P4, P5 to a low-temperature radiator 128, respectively. A pump 122, an electricity supply unit (ESU) 123, a power control unit (PCU) 124, and a motor generator (MG) 125 are arranged in the channel 120c. The MG 125 is a traction motor for the vehicle 1, and drives the vehicle 1 using power from the battery 200. When the ports P4, P5 are connected and the pump 122 is operated, the low-temperature-side heat transfer medium circulates through the channels 120c, 120d. The low-temperature-side heat transfer medium exchanges heat with the ESU 123, the PCU 124, and the MG 125, and dissipates the heat from the ESU 123, the PCU 124, and the MG 125 to the outside air via the low-temperature radiator 128. The ESU 123, the PCU 124, and the MG 125 are thus cooled.

A refrigerant circulates through the refrigerant circuit 150. The refrigerant may be, for example, a hydrofluorocarbon (HFC), ammonia, or carbon dioxide. The refrigerant circuit 150 includes a compressor 151, an electric expansion valve 152, an evaporator 153, an evaporative pressure regulator (EPR) 154, and an electric expansion valve 155. The compressor 151 compresses and discharges the refrigerant that has flowed out of the evaporator 153 and the chiller 160.t. The refrigerant circuit 150 is a refrigeration cycle. The refrigerant circuit 150 corresponds to the “refrigeration cycle” of the present disclosure.

The evaporator 153 is used as a cooling source for the air conditioning unit 2. The condenser 140 is connected to both the first circuit 110 and the refrigerant circuit 150, and serves as a heat exchanger. During operation of the refrigeration cycle (when the compressor 151 is operating), the condenser 140 enables heat exchange between the high-temperature-side heat transfer medium flowing through the first circuit 110 and the refrigerant circulating through the refrigerant circuit 150. The chiller 160 is connected to both the refrigerant circuit 150 and the channel 120a, and serves as a heat exchanger. The chiller 160 enables heat exchange between the refrigerant circulating through the refrigerant circuit 150 and the low-temperature-side heat transfer medium flowing through the second circuit 120 (channel 120a). As described above, the condenser 140, the refrigerant circuit 150, and the chiller 160 are configured to enable heat transfer between the high-temperature-side heat transfer medium flowing through the first circuit 110 and the low-temperature-side heat transfer medium flowing through the second circuit 120.

The air conditioning unit 2 can heat the vehicle cabin using heat dissipated from the condenser 140. During heating operation of the air conditioning unit 2, ports Pa, Pb of the four-way valve 113 are connected, and the high-temperature-side heat transfer medium that has absorbed heat in the condenser 140 dissipates heat in the heater core 114. Heating is thus performed.

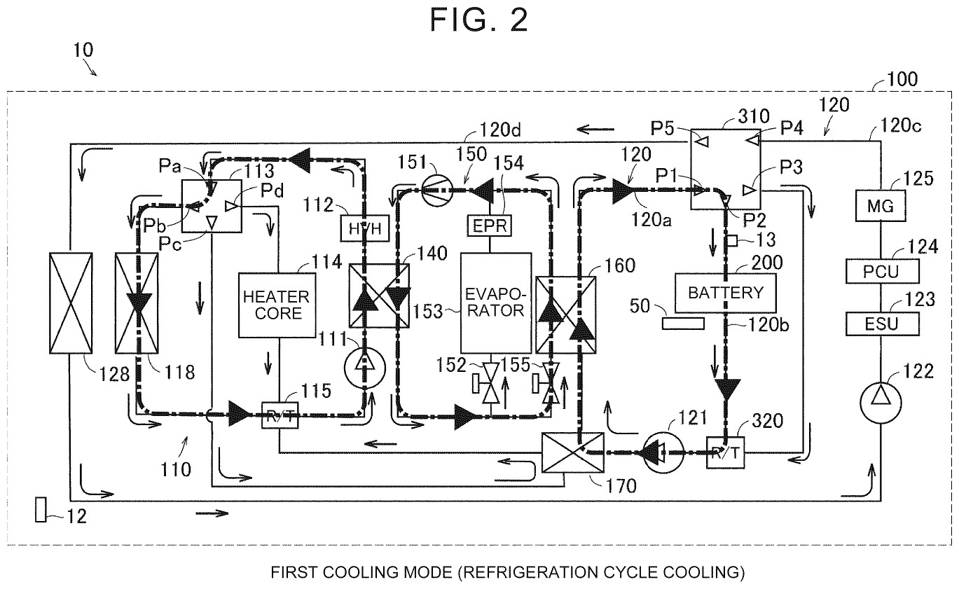

FIG. 2 illustrates a first cooling mode according to the present embodiment. The first cooling mode is a mode in which the battery 200 is cooled using the refrigeration cycle (refrigerant circuit 150). In the first cooling mode, the ports P1, P2 of the five-way valve 310 are connected, and the ports Pa, Pb of the four-way valve 113 are connected. The compressor 151, the pump 111, and the pump 121 are then operated. In FIG. 2, long dashed short dashed lines with arrows indicate the flow of the first circuit 110 (high-temperature-side heat transfer medium), the second circuit 120 (low-temperature-side heat transfer medium), and the refrigerant circuit 150 (refrigerant).

In the first cooling mode, the refrigeration cycle (refrigerant circuit 150) operates, and in the condenser 140, the refrigerant dissipates heat to the high-temperature-side heat transfer medium in the first circuit 110 and condenses. Then, in the chiller 160, the refrigerant absorbs heat from the low-temperature-side heat transfer medium in the channel 120a and evaporates. The high-temperature heat transfer medium that has absorbed heat from the refrigerant in the condenser 140 and become hot circulates through the first circuit 110 and dissipates heat to the outside air via the high-temperature radiator 118. The high-temperature heat transfer medium is thus cooled.

In the second circuit 120, the low-temperature-side heat transfer medium that has lost heat to the refrigerant (refrigerant circuit 150) in the chiller 160 exchanges heat with the battery 200 (absorbs heat from the battery 200), thereby cooling the battery 200.

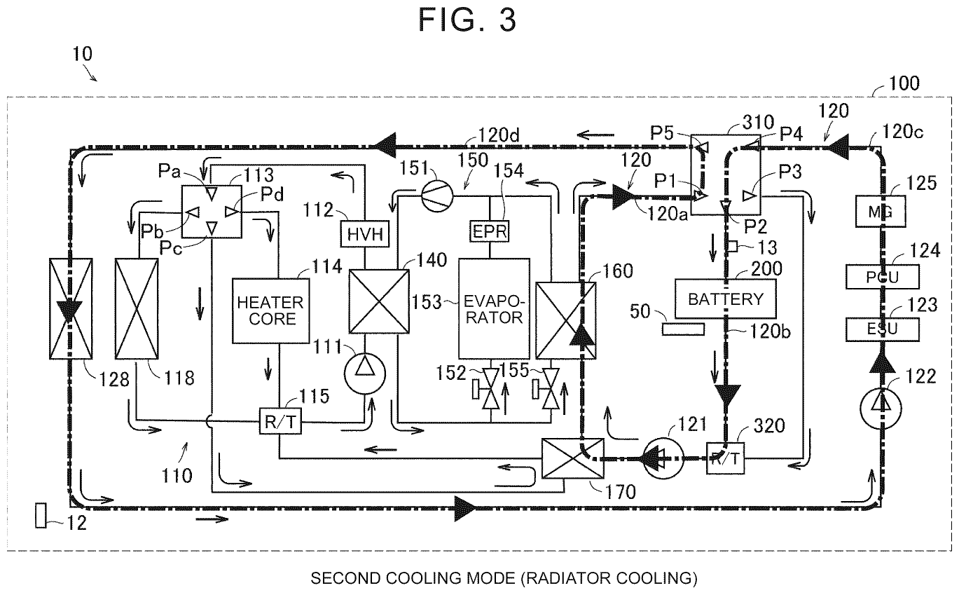

FIG. 3 illustrates a second cooling mode according to the embodiment. The second cooling mode is a mode in which the battery 200 is cooled by heat dissipation from the low-temperature radiator 128. In the second cooling mode, the ports P1, P5 of the five-way valve 310 are connected, and the ports P2, P4 thereof are connected. The pumps 121, 122 are then operated. In FIG. 3, long dashed short dashed lines with arrows indicate the flow of the second circuit 120 (low-temperature-side heat transfer medium).

In the second cooling mode, the low-temperature-side heat transfer medium that has exchanged heat with the battery 200 (has absorbed heat from the battery 200) dissipates the heat to the outside air via the low-temperature radiator 128. The low-temperature-side heat transfer medium cooled by the heat dissipation to the outside air circulates through the second circuit 120 and cools the battery 200. The low-temperature radiator 128 is an example of the “radiator” of the present disclosure.

In the present embodiment, the pump 111, the electric heater 112, the pump 121, the pump 122, and the compressor 151 are driven by power from the battery 200. Alternatively, these devices may be driven by power from an auxiliary battery that is charged using power from the battery 200.

When there is a request to cool the battery 200 and the temperature of the battery 200 is high, cooling in the first cooling mode that uses the refrigeration cycle is preferable in order to appropriately cool the battery 200. However, operating the compressor 151 of the refrigeration cycle (refrigerant circuit 150) consumes power from the battery 200, which reduces the driving range of the vehicle 1. When there is a request to cool the battery 200 but the temperature of the battery 200 is relatively low, the battery 200 is cooled in the second cooling mode that uses heat dissipation from the low-temperature radiator 128, whereby the battery 200 can be maintained at an appropriate temperature. However, in high ambient temperature environments, the amount of heat dissipated from the low-temperature radiator 128 decreases. Therefore, the cooling capacity of the second cooling mode may decrease (sufficient cooling may not be ensured), making it difficult to maintain the battery 200 at an appropriate temperature. Accordingly, it is desirable to appropriately select between the first and second cooling modes.

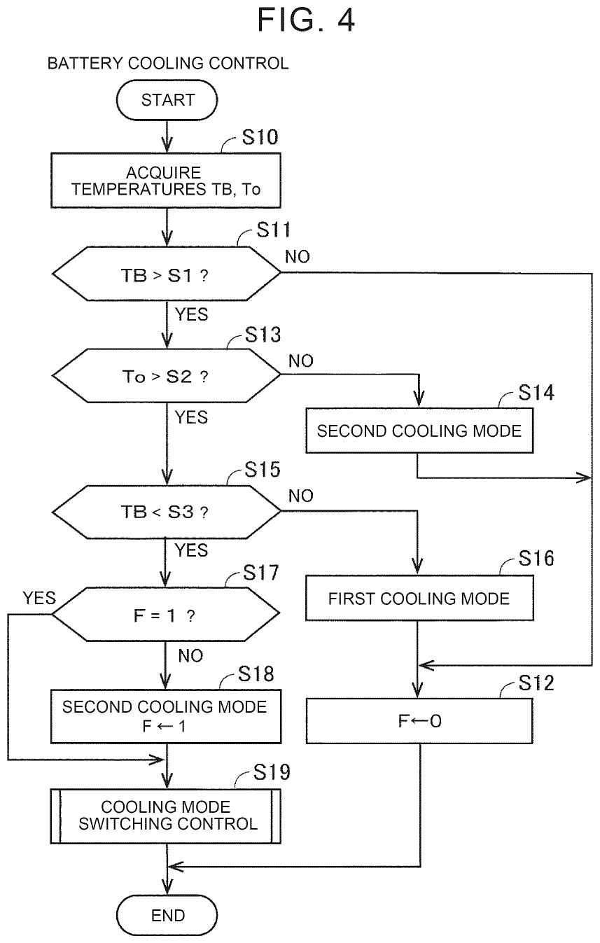

FIG. 4 is a flowchart illustrating processing of battery cooling control that is performed by the ECU 500. This flowchart is repeatedly executed at predetermined intervals while the vehicle 1 is traveling (when a power switch, not shown, is ON) and while the battery 200 is being externally charged.

In step (hereinafter abbreviated as “S”) 10, the temperature TB of the battery 200 and the outside air temperature To are acquired. The temperature TB may be a value detected by the monitoring unit 50. The outside air temperature To may be a value detected by an outside air temperature sensor 12 (see FIG. 1).

In S11, it is determined whether the temperature TB is higher than a threshold S1. The threshold S1 is a temperature used to determine whether to cool the battery 200, and is set in advance through experiments etc. When the temperature TB is lower than or equal to the threshold S1 (NO in S11), it is determined that there is no request to cool the battery 200, and the process proceeds to S12. In S12, a flag F is set to zero, and the current routine ends. In this case, since there is no request to cool the battery 200, cooling of the battery 200 is not performed. When the temperature TB is higher than the threshold S1 (YES in S11), there is a request to cool the battery 200, and the process proceeds to S13.

In S13, it is determined whether the outside air temperature To is higher than a threshold S2. The threshold S2 is, for example, an outside air temperature at which sufficient cooling performance for the battery 200 can be achieved even by heat dissipation from the low-temperature radiator 128. Alternatively, the threshold S2 may be set to an outside air temperature low enough that operating the compressor 151 could result in damage to the compressor 151 due to oil starvation. The threshold S2 is set in advance through experiments etc. The threshold S2 may be, for example, 0° C.

When it is determined in S13 that the outside air temperature To is lower than or equal to the threshold S2 (NO in S13), the process proceeds to S14. When it is determined in S13 that the outside air temperature To is higher than the threshold S2 (YES in S13), the process proceeds to S15. The threshold S2 corresponds to the “second set temperature” of the present disclosure.

In S14, the second cooling mode is selected, and the process then proceeds to S12. When the second cooling mode is selected, the ports P1, P5 of the five-way valve 310 are connected, and the ports P2, P4 thereof are connected. The pumps 121, 122 are then operated to cool the battery 200 in the second cooling mode described with reference to FIG. 3.

In S15, it is determined whether the temperature TB is lower than a threshold S3. The threshold S3 is a temperature at which the battery 200 is desired to be reliably cooled with high cooling capacity in order to reduce the possibility that the temperature TB of the battery 200 becomes excessively high and accelerates degradation of the battery 200. The threshold T3 is set in advance through experiments etc. When the temperature TB is higher than or equal to the threshold S3 (NO in S15), the process proceeds to S16. When the temperature TB is lower than the threshold S3 (YES in S15), the process proceeds to S17. The threshold S3 corresponds to the “first set temperature” of the present disclosure.

In S16, the first cooling mode is selected, and the process then proceeds to S12. When the first cooling mode is selected, the ports P1, P2 of the five-way valve 310 are connected, and the ports Pa, Pb of the four-way valve 113 are connected. The compressor 151, the pump 111, and the pump 121 are then operated, and the battery 200 is cooled using the first cooling mode described with reference to FIG. 2.

In S17, it is determined whether the flag F is 1. The flag F is set to zero in S12, and is set to 1 in S18. When S17 is performed before S18, the flag F is zero (NO in S17), and the process proceeds to S18. When S18 was performed in the previous routine, the flag F is 1 (YES in S17), and the program proceeds to S19.

In S18, the second cooling mode is selected, and the flag F is set to 1. The process then proceeds to S19. When the second cooling mode is selected, the battery 200 is cooled in the second cooling mode.

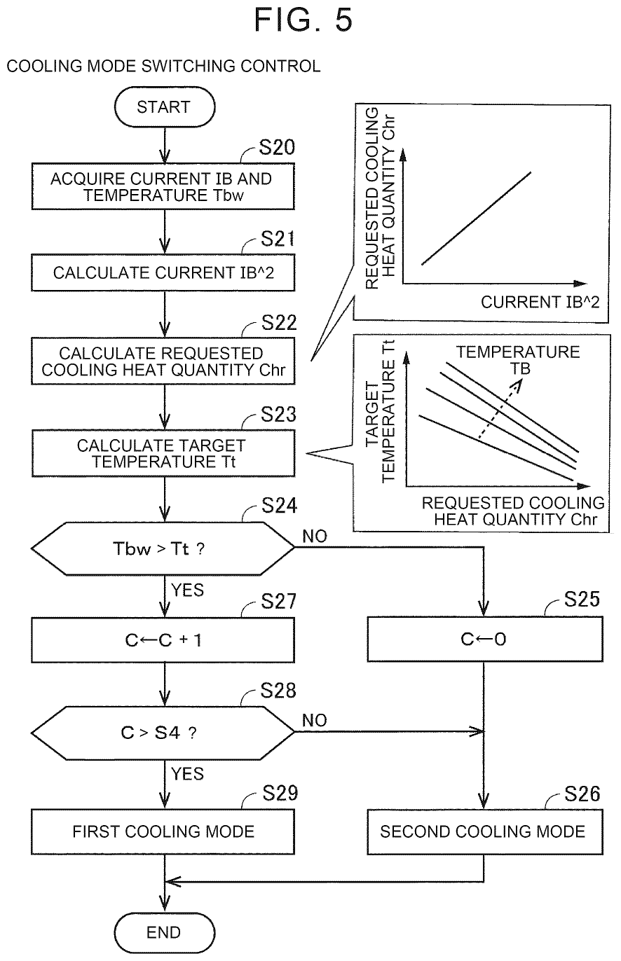

In S19, cooling mode switching control is performed. FIG. 5 is a flowchart illustrating processing of the cooling mode switching control. In S20, the input or output current IB of the battery 200 and the temperature Tbw of the low-temperature-side heat transfer medium are acquired. The input or output current IB may be a value detected by the monitoring unit 50. The temperature Tbw is the temperature of the low-temperature-side heat transfer medium flowing into the battery 200, and may be a value detected by a temperature sensor 13 (see FIG. 1) provided in the channel 120b between the port P2 of the five-way valve 310 and the battery 200.

In S21, the square of the input or output current IB (IB\hat{ }2) is calculated. Thereafter, in S22, a requested cooling heat quantity Chr is calculated based on IB\hat{ }2. In order to cool the battery 200, it is desirable that the amount of heat transferred from the battery 200 to the low-temperature-side heat transfer medium be greater than the amount of heat generated by the battery 200. Since the amount of heat (W) generated by the battery 200 is known to be expressed as R×IB\hat{ }2(where R represents the internal resistance of the battery 200), the requested cooling heat quantity Chr may be calculated from a map that uses the square of the input or output current IB (IB\hat{ }2) as a parameter. The map may be prepared in advance through experiments etc.

In S23, a target temperature Tt for the low-temperature-side heat transfer medium is calculated. The amount of heat dissipated from the battery 200 varies depending on the difference ΔT between the temperature TB and the outside air temperature To and the flow rate of the low-temperature-side heat transfer medium. The flow rate of the low-temperature-side heat transfer medium is determined by the capacity of the pump 121 (and the pump 122). The greater the requested cooling heat quantity Chr is, the greater the difference ΔT is desired to be set. Therefore, as the requested cooling heat quantity Chr increases, the target temperature Tt becomes lower. In S23, the calculation is performed from a map that uses the requested cooling heat quantity Chr and the temperature TB as parameters. The map may be set in advance through experiments etc. The target temperature Tt tends to become lower as the requested cooling heat quantity Chr increases and the temperature TB decreases.

In S24, it is determined whether the temperature Tbw detected in S20 is higher than the target temperature Tt. When the temperature Tbw is lower than or equal to the target temperature Tt (Tbw≤Tt) (NO in S24), the process proceeds to S25, where a counter C is set to zero. The process then proceeds to S26. In S26, the second cooling mode is selected, and the current routine ends.

When the temperature Tbw is higher than the target temperature Tt (Tbw>Tt) (YES in S24), the process proceeds to S27. In S27, the counter C is incremented (1 is added to the counter C), and the process proceeds to S28.

In S28, it is determined whether the counter C is greater than a threshold S4. The threshold S4 is a value set such that, even when the condition in which the temperature Tbw is higher than the target temperature Tt continues for a time equivalent to the threshold S4 or longer, the temperature TB of the battery 200 may not decrease and the battery 200 may be adversely affected. The threshold S4 may be set through experiments, simulations, etc. When the counter C is less than or equal to the threshold S4 (C≤S4) (NO in S28), the process proceeds to S26. When the counter C is greater than the threshold S4 (C>4) (YES in S28), the process proceeds to S29. In S29, the first cooling mode is selected, and the current routine ends.

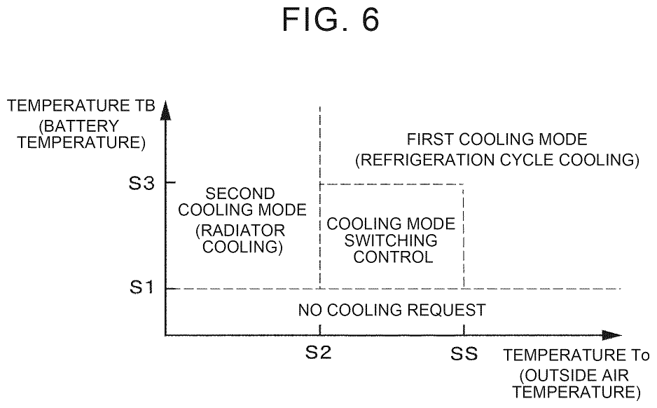

FIG. 6 is a graph illustrating regions of the cooling modes according to the present embodiment. In FIG. 6, the vertical axis represents the temperature TB of the battery 200, and the horizontal axis represents the outside air temperature To. In a region where the temperature TB is lower than threshold S1, there is no request to cool the battery 200, and cooling of the battery 200 is not performed. In a region where the temperature TB is higher than or equal to the threshold S1, there is a request to cool the battery 200. Therefore, the battery 200 is cooled.

When there is a request to cool the battery 200 (when the temperature TB is higher than or equal to the threshold S1), the second cooling mode is set in a region where the outside air temperature To is lower than or equal to the threshold S2. In this region, heat of the low-temperature-side heat transfer medium is dissipated to the outside air via the low-temperature radiator 128 to cool the battery 200. When the outside air temperature To is lower than the threshold S2 and the cooling capacity of the second cooling mode is high, the battery 200 is cooled in the second cooling mode. This can reduce energy consumption of the refrigeration cycle.

In a region where the outside air temperature To is higher than the threshold S2 and the temperature TB is higher than or equal to the threshold S3, the first cooling mode is set, and the battery 200 is cooled using the refrigeration cycle (refrigerant circuit 150). When the temperature TB is higher than or equal to the threshold S3, namely the battery 200 is relatively hot, the refrigeration cycle is used to cool the battery 200 and maintain the battery 200 at an appropriate temperature.

In a region where the temperature TB is lower than the threshold S3 and the outside air temperature To is higher than the threshold S2, either the first cooling mode or the second cooling mode is selected by the cooling mode switching control (see FIG. 5). When the outside air temperature To is higher than or equal to a threshold SS, the first cooling mode may be selected. The threshold SS may be the temperature TB of the battery 200. In an environment where the outside air temperature To is higher than or equal to the temperature TB, it is difficult to cool the battery 200 via heat dissipation from the low-temperature radiator 128. Therefore, when the outside air temperature To is higher than or equal to the threshold SS, the first cooling mode may be selected before an affirmative determination is made in S28 of the cooling mode switching control. The threshold SS is an example of the “third set temperature” of the present disclosure.

In the cooling mode switching control, when the temperature Tbw of the low-temperature-side heat transfer medium is lower than or equal to the target temperature Tt (when NO in S24), the second cooling mode is selected. When the condition in which the temperature Tbw is higher than the target temperature Tt continues for a predetermined time or longer (when the counter C exceeds the threshold S4 and an affirmative determination is made in S28), the first cooling mode is selected. When the temperature Tbw is lower than or equal to the target temperature Tt, the amount of heat transferred from the battery 200 to the low-temperature-side heat transfer medium is relatively large. Therefore, the battery 200 can be maintained at an appropriate temperature by the second cooling mode. When the condition in which the temperature Tbw is higher than the target temperature Tt continues for a predetermined time or longer, it can be determined that the cooling capacity of the second cooling mode is insufficient. Therefore, cooling is performed in the first cooling mode. The battery 200 can thus be maintained at an appropriate temperature.

The target temperature Tt is set based on the requested cooling heat quantity Chr calculated based on the input or output current IB of the battery 200. Since the requested cooling heat quantity Chr takes into account the amount of heat generated by the battery 200, the target temperature Tt can be set based on the amount of heat generated by the battery 200, and the first cooling mode or the second cooling mode can be appropriately selected.

The embodiment disclosed herein should be construed as illustrative in all respects and not restrictive. The scope of the present disclosure is set forth in the claims rather than in the above description of the embodiment and is intended to include all modifications within the meaning and scope equivalent to the claims.

What is claimed is:

1. A battery temperature control device comprising:
a battery thermal circuit configured to circulate a heat transfer medium to control a temperature of a battery; and
a control device configured to select between a first cooling mode and a second cooling mode, the first cooling mode being a mode in which the battery is cooled by cooling the heat transfer medium using a refrigeration cycle, and the second cooling mode being a mode in which the battery is cooled by dissipating heat of the heat transfer medium to outside air via a radiator, wherein:
the control device is configured to
when there is a request to cool the battery, and the temperature of the battery is lower than or equal to a first set temperature and an outside air temperature is higher than or equal to a second set temperature,
select the second cooling mode when a temperature of the heat transfer medium is lower than or equal to a target temperature, and
select the first cooling mode when a condition in which the temperature of the heat transfer medium is higher than the target temperature continues for a predetermined time or longer.

2. The battery temperature control device according to claim 1, wherein the control device is configured to set the target temperature based on an input or output current of the battery.

3. The battery temperature control device according to claim 1, wherein the control device is configured to select the second cooling mode when the outside air temperature is lower than the second set temperature.

4. The battery temperature control device according to claim 3, wherein the control device is configured to select the first cooling mode when the temperature of the battery is higher than the first set temperature.

5. The battery temperature control device according to claim 1, wherein the control device is configured to select the first cooling mode when the outside air temperature is higher than or equal to a third set temperature that is higher than the second set temperature.
